(19) United States
(12) Patent Application Publication
(10) Pub. No.: US 2005/0144055 A1
(43) Pub. Date: Jun. 30, 2005

(54) Method and apparatus for multiple output planning

(76) Inventors: Frank Horlacher, Nussloch (DE); Peter Schmidt, Verl (DE)

Correspondence Address: KENYON & KENYON, 1500 K STREET, N.W., SUITE 700, WASHINGTON, DC, 20005, US

(21) Appl. No.: 10/747,141

(22) Filed: Dec. 30, 2003

(51) Int. Cl. G06F 17/60

(52) U.S. Cl. 705/8

(57) ABSTRACT

Embodiments of the present invention provide integrated, flexible and automated functionality for processing a customer's orders or other demands. In one embodiment, a multiple output planning order may be generated based on one or more requirement elements. One or more product receipt elements that can be used to complete the generated multiple output planning order may be identified. The identified one or more product receipt elements to cover a first one of the requirement elements and a second one of the requirement elements included in the generated multiple output planning order. The availability of the multiple output planning order based on a date and time associated with the requirement elements, and availability of the receipt elements may be scheduled.

### BACKGROUND OF THE INVENTION

The present invention relates to a method and apparatus for managing production orders. In particular, the present invention relates to a method and apparatus for planning and processing orders with multiple output products.

Many companies use planning and/or scheduling systems to process requirement elements (e.g., customer demands) for goods and/or services. Manufacturers may often rely on such systems to manage and integrate business processes to complete customer or other requests. Companies that supply metal products, forest products, textiles and building materials have to schedule and manage customer order demands or other demands, product production and delivery in a timely manner. These industries are faced with peculiar supply chain management challenges as they produce complex products with various product, dimension, quality, and process attributes. Companies which provide such products and/or services are straining to improve customer relationships, services and in-house production chains to be competitive and maintain customer loyalty.

Conventional planning systems are based on the demand which defines the operations and supply of outputs. Such systems do not always utilize its resources efficiently and suffer from increased inventory, storage costs, wastage and/or administration costs.

A system that provides solutions for adaptive supply chain management, efficient enterprise asset management, and improved customer relationship management is desirable.

### BRIEF DESCRIPTION OF THE DRAWINGS

FIG. 1 is a block diagram illustrating a multiple output planning system in accordance with embodiments of the present invention.

FIG. 2 is a block diagram of a multiple output planning device in accordance with an embodiment of the present invention.

FIG. 3 is a flowchart illustrating a method in accordance with an embodiment of the present invention.

FIG. 4 is a flowchart illustrating a method in accordance with an embodiment of the present invention.

FIGS. 5A and 5B are block diagrams of a multiple output planning process in accordance with an embodiment of the present invention.

### DETAILED DESCRIPTION

Embodiments of the present invention relate to a multiple output planning (MOP) method and apparatus.

The input material used for production often determines the production steps and their output. For example, products produced by the mills industry are typically variants produced by cutting input materials such as slabs, containers, and/or jumbo rolls. MOP enables efficient ordering, use, processing and/or delivery of products to customers. For example, when completing a product order, MOP enables production steps and off-cuts (e.g., leftover material) to be configurable depending on the product identified to complete the order. The MOP system may select products that most efficiently utilize resources, existing inventory, and/or planned receipt elements so that off-cuts can be used to fulfill additional requirements. MOP can be available in multiple levels of production.

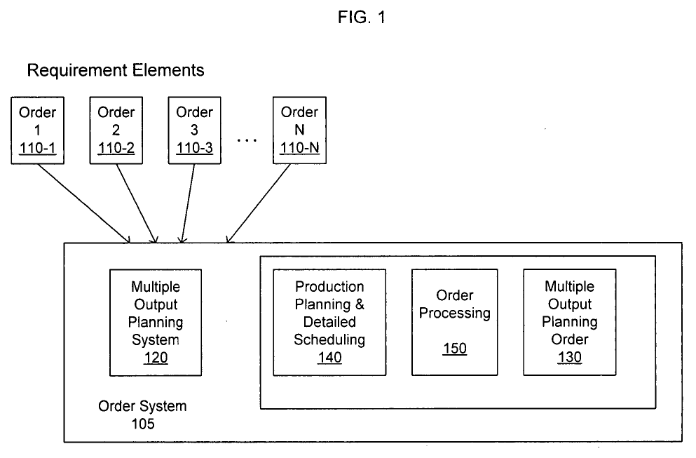

FIG. 1a is a block diagram illustrating how requirement element may be processed in accordance with embodiments of the present invention. Requirement elements may be, for example, demand, customer requirements, forecast demand, etc. As shown in FIG. 1, one or more requirement elements 110-1 to 110-N may be received at a multiple output planning (MOP) system 120. The MOP system 120 may process the one or more requirement elements 110-1 to 110-N and produce one or more MOP orders 130. The MOP order 130 may be used for production planning and detailed scheduling purposes 140. The order may be processed through the remainder of the order processing system 150 and a product may be output to complete the order in accordance with embodiments of the present invention.

In embodiments of the present invention, the MOP system may be used to plan production and/or determine delivery for products and/or services as required by customers. The products and/or services may be delivered while efficiently utilizing resources and material that may be used to deliver the products.

In embodiments of the invention, requirement elements 110-1 to 110-N may include product criteria such as identification, description and/or other characteristics associated with the desired product. For example, such information may identify the product as well as include the quantity, quality and/or other information associated with the desired product. Other information that may be included with the one or more requirement elements 110-1 to 110-N may include delivery dates and/or times that indicate when the product and/or services may be required by the customer. As one or more requirement elements 110-1 to 110-N are received, they may be input and processed by the MOP system 120, in accordance with embodiments of the present invention.

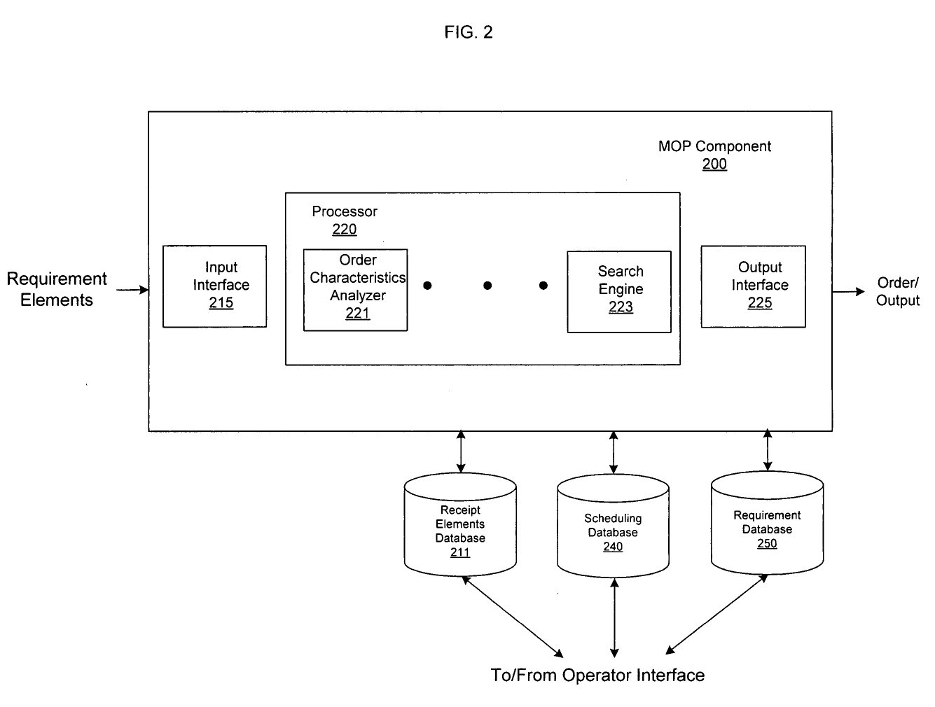

FIG. 2 is a block diagram of MOP component 200 that may be used to process requirement elements in accordance with an embodiment of the present invention. The MOP component 200 may include, for example, input interface 215, processor 220 and output interface 225. It is recognized that the MOP component 200 may include additional components that have been omitted for simplicity. The MOP component 200 may be coupled with one or more databases such as receipt elements database 211, scheduling database 240, requirement elements database 250 and/or any other database.

In embodiments of the present invention, MOP component 200 may be incorporated in a MOP system such as system 120 and/or any other order processing system to process one or more requirement elements in accordance with embodiments of the present invention. One or more requirement elements may be received at MOP component 200 via interface 215. The order analyzer 221 may analyze the characteristics of the requirement elements and/or criteria associated with the requirement elements to determine which products and/or services are desired. For example, the characteristics of the requirement elements may include the name or identity of the product, the desired quantity, quality, delivery dates, and/or any other information related to the order and/or the requested product. The analyzer may retrieve such information and this information may be used by the search engine 223 to find receipt elements that may be used to complete or fulfill the pending requirement element. A receipt element may be defined as an element of an order that represents the availability date, the quantity of a product that is provided by the order.

In embodiments of the present invention, the search engine 223 may search receipt element database 211 and/or any other database for the product that can be used to complete the received order. For example, the search engine 223 may search the receipt elements database 211 for product receipts or receipt elements that have characteristics value assignments that match the characteristics value assignments associated with the one or more product(s) associated with the one or more requirement elements.

In embodiments of the present invention, other characteristics that may be considered when searching for receipt elements may include, for example, location of the product, account assignment, planning version, dimensions, etc. By comparing the value assignments of the receipt elements with requirement criteria of the product required, the MOP component 200 may determine the receipts that can be used to complete the order.

In embodiments of the present invention, the MOP component 200 may include other factors such as availability of resources to complete the order, quantity of off-cuts (e.g., leftover material) and or other information.

If the MOP component 200 can identify a suitable receipt element to cover the pending order, the identified receipt element may be selected to complete the order. If the MOP component 200 cannot find a suitable receipt element to cover the pending order, the MOP operation may be implemented in accordance with embodiments of the present invention. In an embodiment of the present invention, the search engine 223 included in the MOP component 200 may perform a receipt search at a previous manufacturing level to identify a suitable receipt element that may be produced to cover the pending order. In embodiments of the present invention, the MOP component 200 may take into account existing receipt elements in stock as well as planned and/or in-production receipt elements.

In embodiments of the present invention, if the MOP component 200 is still unable to complete the customer's order, the order analyzer 221 may analyze the product requirements and the search engine 223 may perform another receipt search to determine suitable receipt elements from other stages of production to cover the pending requirement elements. The other manufacturing levels may include pre-production levels and/or any other stages of production that may include material to cover the pending order. The MOP component 200 may determine all the parameters or the like that are needed for generating the MOP order, in accordance with embodiments of the present invention. The MOP component 200 may determine all components that are needed for the generation of the MOP order and may also generate additional material or products that may result in the form of off-cuts or surplus products. In embodiments of the present invention, the surplus products (e.g., surplus receipt elements) may be returned to stock and/or used to complete other requirement elements. If the surplus receipt elements are to be returned to stock, the surplus receipt elements may be returned to the inventory database 270.

In embodiments of the present invention, a production order such as order 140 may be generated from the MOP order such as MOP order 130 that may be generated by the MOP component 200 in accordance with embodiments of the present invention. Based on a bill of material, a routing order and/or other information leading to a production process model, an appropriate order structure may be created for a production order. If surplus receipt elements were generated in the MOP order process, these may be included in the order structure as additional items, for example, co-products. Thus, the production order may be created by the MOP device based on the production process model or bill of material and a routing order.

It is recognized that the MOP process as described herein and/shown in the figures can have myriad applications. For example, MOP can be used in providing paper, textile, steel, cables, lumber, metal sheets, metal blocks, etc. Thus, the MOP process can be applied or used when processing orders for any type of products and/or material.

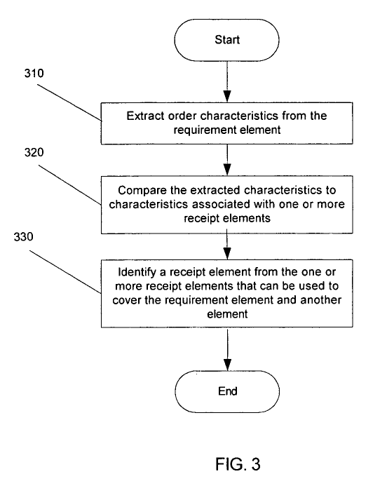

FIG. 3 is a flow chart illustrating a method in accordance with an embodiment of the present invention. As shown in box 310, responsive to an order from a customer, order characteristics may be extracted from the customer's order. The extracted characteristics may be compared to characteristics associated with one or more receipt elements, as shown in box 320. These receipt elements may be from existing receipt elements and/or from one or more receipt elements that are planned for production. As shown in box 330, a receipt element, from the one or more receipt elements, that can be used to cover the customer's order and another order may be identified. The identified receipt element may be selected in order to minimize waste and efficiently allocate resources.

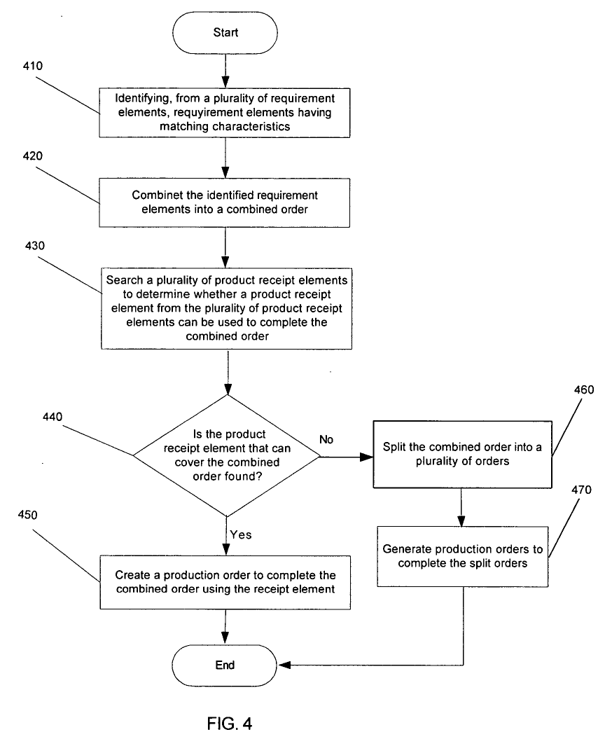

FIG. 4 is a flow chart illustrating a method in accordance with an embodiment of the present invention. As shown in box 410, requirement elements having matching characteristics may be identified from a plurality of requirement elements. The identified requirement elements may be combined into a combined order, as shown in box 420. A plurality of product receipt elements may be searched to determine whether a product receipt element from the plurality of product receipt elements can be used to complete the combined order for the identified requirement elements, as shown in box 430. If the product receipt element that can cover the combined order is found, a production order to complete the combined order may be created using the product receipt element found, as shown in boxes 440 and 450.

If, however, the product receipt element that can cover the combined order is not found, a plurality of orders may be created, as shown in boxes 440 and 460. As shown in box 470, production orders to complete the one or more orders may be generated.

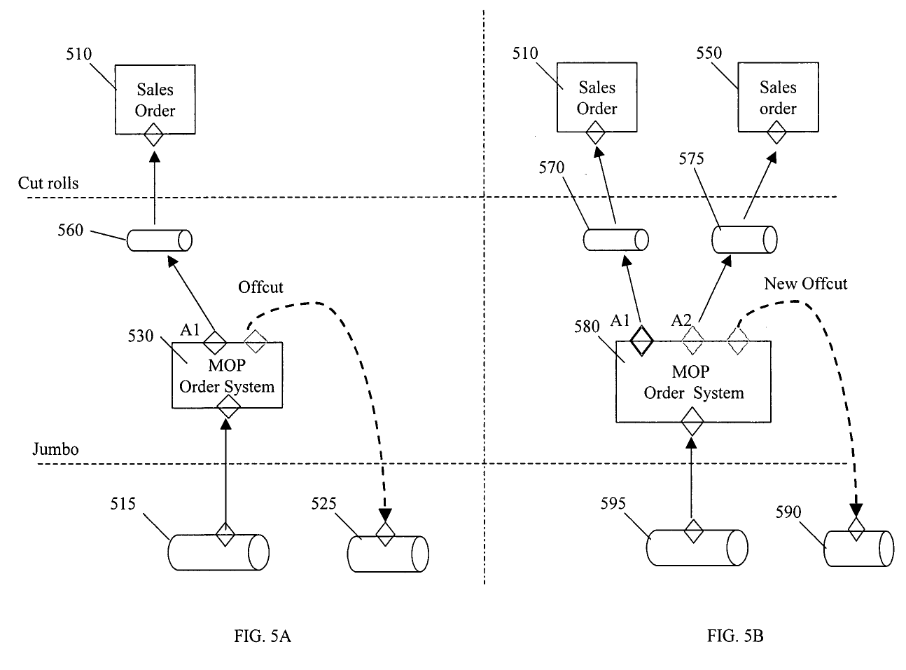

FIGS. 5A and 5B are block diagrams illustrating embodiments of the present invention. In FIG. 5A, a sales order 510 including one or more requirement elements may be generated. A product search may search for one or more products or receipt elements that may be used to fulfill or cover the sales order. The characteristic values associated with the requirement element may be, for example, sheet metal rolls that are 600 units wide and 10,000 units long. It is recognized that the requirement element may have additional characteristic values (color, thichkness, type, quality, quantity, etc) associated with it. The measurements units may be any unit(s) desirable. In embodiments of the present invention, a receipt element 515 may be identified to cover the requirement.

In an embodiment of the present invention, the characteristic values of the requirement element may be used to search for one or more receipt elements. This information may be compared. A receipt element that has characteristic values closer to values associated with the requirement element may be searched for a match. As indicated MOP order system 530 may identify the receipt element 515 to cover the order. The MOP system 560 may generate requirement 560 from the receipt element 515. In embodiments of the present invention, the may generate an off-cut 525 that may be, for example, put back into stock, put into planned production, sold to another party, used to complete another order, etc. The off-cut may be used to complete another order such as another sales order 550, as shown in FIG. 5B.

In FIG. 5B, MOP order system 580 may process both sales orders 510 and 550 in a combined MOP process. For example, the MOP system 580 may combine a search to identify receipt elements to cover the requirement elements as identified by the sales orders 510 and 550. In this manner, the MOP system 580 may be able to efficiently complete both orders, for example, and minimize waste. It is recognized that the MOP system 580 may combine more than two orders. The MOP system 580 may identify receipt element 595 to cover both sales orders 510 and 550. The MOP system 580 may assign requirement elements 560 and 570 for these sales orders. In embodiments of the present invention, the MOP system 580 may generate off-cut 590 which may be, for example, put back into stock, put into planned production, sold to another party, used to complete another order, etc.

In embodiments of the present invention, the MOP system may conduct an extended inventory stock search that may be designed to find the smallest or closest product that can cover or fulfill the requirement. The MOP system may use appropriate macros or the like to perform remainder calculations to determine the quantity of the remaining off-cuts. The MOP system may use bottom up propagation to determine which equipment may be used to process the requirement element to fulfill the pending one or more orders. Moreover, the MOP system may combine two requirements into one planned order so that resources may be used efficiently while minimizing waste.

It is recognized that embodiments of the present invention may be processed in a standalone and/or network computer. For example, the MOP system 120 and/or MOP component 200 may be incorporated in and/or implemented using a standalone computer and/or a computer network. It is recognized that the various databases as described herein may be located in any type of data storage device or memory. These storage memories may be located internal to and/or internal to these computers. Appropriate communications networks, interfaces and/or other hardware may be included in the MOP system described herein, in accordance with embodiments of the present invention.

It is recognized that a computer or other processing device on which embodiments of the present invention may be processed, may contain the appropriate software and/or hardware to carry out the functionality as described herein. Appropriate fields in the various databases described herein may be searched for product related information. A program or macro may be created that may specify the fields to search based on the type of information required.

Several embodiments of the present invention are specifically illustrated and described herein. However, it will be appreciated that modifications and variations of the present invention are covered by the above teachings and within the purview of the appended claims without departing from the spirit and intended scope of the invention.

1. A method for processing demands, comprising:
generating a multiple output planning order based on one or more requirement elements;
identifying one or more product receipt elements that can be used to complete the generated multiple output planning order, wherein the identified one or more product receipt elements to cover a first one of the requirement elements and a second one of the requirement elements included in the generated multiple output planning order; and
scheduling availability of the multiple output planning order based on a date and time associated with the requirement elements, and availability of the receipt elements.

2. The method of claim 1, wherein the one or more receipt elements are one or more receipt elements that are planned for production.

3. The method of claim 1, wherein the one or more receipt elements are one or more receipt elements in stock.

4. The method of claim 1, further comprising:
searching for one or more receipt elements based on the first and second requirement element.

5. A method for multiple output planning, comprising:
responsive to a demand for a requirement element, extracting characteristics from the requirement element;
comparing the extracted characteristics to characteristics associated with one or more receipt elements; and
identifying a receipt element from the one or more receipt elements that can be used to cover the requirement element, wherein the identified receipt element is selected based on minimizing waste.

6. The method of claim 5, wherein the one or more receipt elements are one or more existing receipt elements.

7. The method of claim 5, wherein the one or more receipt elements are one or more receipt elements that are planned for production.

8. The method of claim 5, further comprising:
generating a product order based on the identified receipt element.

9. The method of claim 5, wherein the requirement element is associated with metal products.

10. The method of claim 5, wherein the requirement element is associated with wood products.

11. The method of claim 5, wherein the requirement element is associated with fabric products.

12. The method of claim 5, further comprising:
comparing product characteristics associated with the requirement element with product characteristics associated with another requirement element; and
combining the requirement elements, if the product characteristics associated with the requirement element match the product characteristics associated with the another requirement element.

13. A method for completing product orders, comprising:
identifying, from a plurality of requirement elements, requirement elements having matching characteristics;
combining the identified requirement elements into a combined order;
searching a plurality of product receipt elements to determine whether a product receipt element from the plurality of product receipt elements can be used to complete the combined order; and
if the product receipt element that can cover the combined order is found, creating a production order to complete the combined order using the receipt order found.

14. The method of claim 13, further comprising:
splitting the combined order into a plurality of orders, if the product receipt element that can cover the combined order is not found.

15. The method of claim 14, further comprising:
generating production orders from the plurality of orders to complete the split orders.

16. The method of claim 13, wherein characteristics include length, width, thickness, material type and quality type.

17. The method of claim 13, wherein a requirement from the plurality of requirement elements is for paper products.

18. The method of claim 13, wherein a requirement from the plurality of requirement elements is for metal products.

19. The method of claim 13, wherein a requirement from the plurality of requirement elements is for fabric products.
